(19) United States
(12) Patent Application Publication
(10) Pub. No.: US 2026/0332254 A1
(43) Pub. Date: Oct. 22, 2026

(54) Communication Methods and Systems

(71) Applicant: UNIVERSITY OF THE WITWATERSRAND, JOHANNESBURG, Braamfontein (ZA)

(72) Inventors: Andrew FORBES, Braamfontein (ZA); Keshaan SINGH, Braamfontein (ZA)

(73) Assignee: UNIVERSITY OF THE WITWATERSRAND, JOHANNESBURG, Braamfontein (ZA)

(21) Appl. No.: 19/114,710

(22) PCT Filed: Sep. 22, 2023
(86) PCT No.: PCT/IB2023/059376

§ 371 Date: Mar. 24, 2025

(30) Foreign Application Priority Data
Sep. 23, 2022 (ZA) 2022/10546

(51) Int. Cl. H04B 10/079; H04B 10/70

(52) U.S. Cl. CPC H04B 10/079; H04B 10/70

(57) ABSTRACT

This invention relates to methods, a receiver arrangement, a transmitter arrangement, and system comprising both the receiver and transmitter arrangements for optical communication. The invention discloses the processing of a received beam of light carrying information by determining a degree of vectorness of the received beam of light, wherein the determined degree vectorness to determine the information carried by the received beam of light. In this regard, the invention disclosed the use of the vectorness of a beam of light as an encoding basis for optical communication.

### FIELD OF THE INVENTION

The invention relates to communication methods and systems, particularly to optical communication methods and systems which are more resilient in noisy channels, for example atmospheric turbulence and imperfect optical fibre.

### BACKGROUND TO THE INVENTION

Optical communication has been an integral part of human society since recorded time, initially visual and thus free-space based, with wire-based solutions only emerging a couple hundred years ago, from copper wire to modern day fiber optics.

Packing information into light is the cornerstone of modern day communication systems, but the exhaustion of wavelength, amplitude, phase and polarization modulation has left space as the last remaining degree of freedom to be fully exploited. Here, space division multiplexing (SDM) and its sister mode division multiplexing (MDM) hold tremendous potential to increase capacity (or equally but opposite, to increase diversity) through the use of so-called structured light. In optical fibre, space may be exploited by multicore fibres to create physically separated channels, but this is thought to be inefficient due to channel scalability issues. It can also be implemented in multimode fibres, with orthogonal modes occupying the same space but now modally separated. This has cost and efficiency savings but comes with the technological challenge of modal coupling: unwanted noise due to ever-present perturbations. Although post digital processing (such as MIMO) can circumvent this, it is energy inefficient and has only been demonstrated with order-of-magnitude ~10 modes, while customizing the fibre has seen a similar number of modes transmitted with low noise over kilometre length scales.

Free-space optical communication is likewise steadily gaining traction, offering the benefits of low attenuation, large available frequency windows, and a viable solution for last mile problems, and more recently, as a fast connector of telecom towers, now potentially within the range of free-space line-of-sight links. But here, atmospheric turbulence and weak scatters in the atmosphere introduce modal coupling, limiting the reach and the fidelity (capacity) of optical links. This too has limited free-space optical communication with spatial modes of light to a handful of modes over modest distances of less than 300 m.

Fundamentally speaking, the problem is that spatial modes suffer from spatial distortion (often stochastic), and thus any approach that requires the modes to be “recognized” as part of the detection will suffer a similar fate, with an inevitable increase in noise concomitantly with the number of modes. Recalling the dictum that capacity cannot increase if noise increases, the invention seeks to address this problem and at least increase the present modes of optical communication mentioned herein.

### SUMMARY OF THE INVENTION

According to a first aspect of the invention, there is provided a method for optical communication, wherein the method comprises:
receiving a beam of light carrying information; and
determining a degree of vectorness of the received beam of light, wherein the determined degree of vectorness is used to determine the information carried by the received beam of light.

The information carried by the received beam of light may be in the form of bits. The received beam of light may thus be encoded with information comprising one or more bits. The received beam of light may be in the form of a vector beam of light, for example, a vector vortex beam of light. It will be understood by those skilled in the art that the invention disclosed herein uses the degree of vectorness of the received vector beam of light as a basis for optical communication. In this regard, the received beam of light may thus be encoded with information comprising one or more bits using a degree of vectorness of the light beam as an encoding basis.

Determining the degree of vectorness of the received beam of light may in other words comprise determining polarisation inhomogeneity of the received beam of light. In this regard, the method may comprise using the degree of vectorness as a variable basis for optical communication. It will be understood that the phrase “determining a degree of vectorness” may be understood to comprise “detecting a degree of vectorness”. In this way, vector/vectoral modes detected may automatically be detected to determine the information carried by the beam of light. In this regard, the degree of vectoness of the received beam of light may in itself be representative of data.

The degree of vectorness may be a value selected from a range between, and optionally including, zero and one. The said range may be subdivided into a plurality of user defined values or number of steps (N) or vectoral/vector modes (N). Each vector mode or value or step may have one or more bits associated therewith. Advantageously, the number of steps or vector modes N is independent of how perturbing the channel is, which makes the scheme disclosed herein channel invariant. By using the said range, the degree of vectorness may be used as a high/higher-dimensional alphabet than a monotonical alphabet comprising only one and zero, as is typical with conventional amplitude modulation. Notwithstanding, it will be appreciated that nothing precludes the degree of vectorness from used as a two-dimensional alphabet comprising only zero and one.

Determining the degree of vectorness of the received beam of light may comprise determining a measure of quantum entanglement of the received beam of light. Differently stated, the invention disclosed herein may comprise determining a measure of quantum entanglement of the received beam of light; and using the determined measure of quantum entanglement to determine the information carried thereby.

Also, differently stated, determining the degree of vectorness of the received beam of light may comprise determining concurrence of the received beam of light. In this regard, those skilled in the art would appreciate that the “degree of vectorness” of the received beam of light may be the “vectorness” or “measure of quantum entanglement” or “concurrence” of the received beam of light and thus these terms may be used interchangeably herein. The term the “degree of vectorness” may not necessarily mean a singular degree of vectorness being used as an encoding basis but may be understood to represent the use of the vectorness of the beam of light in general as the encoding basis and these may be via one or more vector or vectoral modes described herein. In this regard, the aforementioned terms are also used interchangeably herein with “vectoral/vector modes” as the case may be. It follows that a degree of vectorness of the beam of light may be referred to as a vector mode having a particular degree of vectorness or concurrence or measure of quantum entanglement of the received beam of light associated therewith, wherein the vector mode is used to determine the information carried by the received beam of light as it is used as an encoding basis for optical communication.

The method may comprise determining concurrence of the received beam of light by:
determining integrated Stokes intensity measurements associated with the received beam of light; and
using the determined integrated Stokes intensity measurements to calculate the concurrence.

The method may comprise determining the Stokes intensity measurements by way of a suitable processing arrangement coupled to an optical receiver comprising a Stokes Polarimetry arrangement configured to detect Stokes intensities, with the simplification that the detection does not need to be spatially revolved, and only an integrated signal collected. It will be appreciated that the suitable processing arrangement may be configured to determine the Stokes intensity measurements from suitable electrical signals received from the Stokes Polarimetry arrangement communicatively coupled thereto.

In one example embodiment, the method may comprise:
diffracting the received beam of light into at least four copies of the received beam of the light;
interacting the at least four copies of the received beam of light with one or more optical elements selected from a group comprising quarter-wave plate/s, half-wave plate/s, and lens/es;
detecting each of the at least four copies of the received beam of light after interacting with the one or more optical elements by way of a photosensitive arrangement that collects an integrated signal with no spatial resolution;
determining a horizontally polarised Stokes intensity measurement (Γ_{H}), a vertically polarised Stokes intensity measurement (Γ_{V}), a diagonally polarised Stokes intensity measurement (Γ_{D}), and a right-circularly polarised Stokes intensity measurement (Γ_{R}) associated with the received beam of light from the at least four copies of the received beam of light detected by the photosensitive arrangement; and
using the determined Stokes intensity measurements to calculate the concurrence.

The method may comprise diffracting the received beam of light into the at least four copies of the received beam of the light by way of one or more multiplexed holograms. The method may comprise diffracting the at least four copies of the received beam of light into the ±1 diffraction orders. It will be noted by those of reasonable skill in the art that the methodology and/or arrangement referred to herein to determine the Stokes intensities/intensity measurements may be replaced with any equivalent integrated Stokes measurement apparatus or methodology.

It will be appreciated by those skilled in the art that any combination of optical, and mechanical and/or electrical methodologies and/or arrangements may be used to determine concurrence of the received beam as contemplated herein. For example, the methodology disclosed in International Patent Application no. PCT/IB2017/053624 may be used herein for determining the concurrence of the received beam of light and though various approaches may be used to determine concurrence, these various approaches should not detract from the invention disclosed herein. Similarly, it will also be appreciated by those skilled in the art that any combination of optical, and mechanical and/or electrical methodologies and/or arrangements may be used to encode the received beam of light at a suitable transmitter.

To the end, the method may comprise a step of transmitting the beam of light carrying information. The method may comprise encoding a beam of light with information by using a degree of vectorness of the beam of light as an encoding basis. In particular, the method may comprise encoding a beam of light with information by using a degree of vectorness of the beam of light as a continuous variable encoding basis.

The method may comprise preparing a vector beam of light to be encoded with information.

According to a second aspect of the invention, there is provided a method for optical communication, wherein the method comprises encoding a beam of light with information by using a degree of vectorness of the beam of light as an encoding basis.

The method may comprise preparing a vector beam of light for optical communication. The vector beam may be a vector vortex beam of light.

The method may comprise:
preparing at least two scalar beams of light, each beam of light having a polarisation which is orthogonal to a polarisation of the other beam of light;
modulating one or both of the scalar beams of light in amplitude such that the resultant vector beam of light has a predetermined degree of vectorness or vectoral/vector mode as described herein;
combining the scalar beams of light to generate a vector beam of light comprising the two scalar beams of light; and
transmitting the vector beam of light.

It will be appreciated that each vector/vectoral mode of light may be associated with information for optical communication. In this regard, the method may comprise modulating one of both of the scalar beam/s of light in amplitude such that the generated vector beam of light has a predetermined degree of vectorness or vectoral/vector mode as described herein. The method may comprise modulating the amplitude/s of one or both the scalar beams to have a combined amplitude of 1. In other words, the method may comprise modulating the amplitude/s of one or both the scalar beams such that the total amplitude of the generated vector beam of light remains the same and as high as possible.

The method may comprise combining the scalar beams of light, one or both being modulated in amplitude, to generate a vector beam of light comprising the scalar beams of light.

It will be appreciated that each vector/vectoral mode of light may be associated with information for optical communication. It follows that modulating one or both of the scalar light beam/s in amplitude may comprise encoding information into one or both the scalar light beams by way of amplitude so that the resultant vector beam of light is associated with a particular vectoral/vector mode. In other words, the amplitude of the scalar beam/s may be varied to thereby to vary the vectoral/vector modes and thus the information transmitted.

According to a third aspect of the invention, there is provided a receiver arrangement for optical communication, wherein the receiver arrangement comprises:
an optical receiver configured to receive a beam of light carrying information; and
a processing arrangement communicatively coupled to the optical receiver and configured to determine a degree of vectorness of the beam of light received by the optical receiver, wherein the processing arrangement is configured to use the determined degree of vectorness to determine the information carried by the beam of light received by the optical receiver.

The degree of vectorness may be a value selected from a range between, and optionally including, zero and one. The said range may be subdivided into a plurality of user defined values or number of steps (N) or vectoral/vector modes (N). Each vector mode or value or step may have information in the form of one or more bits associated therewith.

The processing arrangement may be configured to determine the degree of vectorness of the received beam of light by determining concurrence of the received beam of light. In particular, the processing arrangement may be configured to determine concurrence of the received beam of light by:
determining Stokes intensity measurements associated with the received beam of light; and
using the determined Stokes intensity measurements to calculate the concurrence.

The optical receiver may comprise a Stokes Polarimetry arrangement configured to detect Stokes intensities. The Stokes intensity measurements may be integrated Stokes intensity measurements. It will be appreciated that the suitable processing arrangement may be configured to determine the integrated Stokes intensity measurements from suitable electrical signals received from the Stokes Polarimetry arrangement communicatively coupled thereto.

The Stokes Polarimetry arrangement may comprise a suitable holographic device configured to provide one or more holograms to the beam of light received by the optical receiver. The holographic device may be configured to provide suitable multiplexed holograms which are configured to diffract four copies of the received beam of light into ±1 diffraction orders.

The Stokes Polarimetry arrangement further comprises:
a suitable optical arrangement downstream from the holographic device comprising one or more components selected from a group comprising quarter-wave plate/s, half-wave plate/s, linear polariser/s, and lenses; and
a photosensitive arrangement downstream from the optical arrangement configured to detect the Stokes intensities.

The photosensitive arrangement may comprise one or more components selected from a group comprising photodetectors, photodiodes, charge-coupled devices (CCD), and the like. It will be appreciated that the photosensitive arrangement may be configured to collect an integrated signal/beam of light L, with no spatial resolution. In this way, the system disclosed herein may be used with low cost a photosensitive arrangement comprising photodetectors in the form of photodiodes.

The photosensitive arrangement may be configured to generate and send electrical signals the suitable processing arrangement in response to detecting the Stokes intensities.

In one example embodiment, the suitable processor arrangement is configured to:
determine a horizontally polarised Stokes intensity measurement (Γ_{H}), a vertically polarised Stokes intensity measurement (Γ_{V}), a diagonally polarised Stokes intensity measurement (Γ_{D}), and a right-circularly polarised Stokes intensity measurement (Γ_{R}) associated with the received beam of light; and use the determined Stokes intensity measurements to calculate the concurrence.

The optical receiver may be configured receive the beam of light via an optical communication channel which may be selected from a group comprising free space, atmosphere, optical fiber (e.g., single-mode optical fiber), and water, transparent cellular material.

According to a fourth aspect of the invention, there is provided a transmitter arrangement for optical communication, wherein the transmitter arrangement comprises:
a light beam generating arrangement configured to generate and transmit a vector beam of light over a communications channel; and
a suitable encoder configured to encode the beam of light generated by the light beam generating arrangement with information by using a degree of vectorness of the beam of light as an encoding basis.

The light beam generating arrangement may comprise a suitable light source and suitable optical and/or holographic elements configured to prepare a vector beam of light for optical communication. The vector beam of light may be a vector vortex beam of light.

The light beam generating arrangement may be configured to prepare at least two scalar beams of light to be used to generate the vector beam of light, each scalar beam of light having a polarisation which is orthogonal to a polarisation of the other beam of light.

In this regard, the encoder may be configured to modulate one of both of the scalar beam/s of light in amplitude such that the generated vector beam of light has a predetermined degree of vectorness or vectoral/vector mode as described herein. The encoder may be configured to modulate the amplitude/s of one or both the scalar beams to have a combined amplitude of 1. In other words, the encoder may be configured to modulate the amplitude/s of one or both the scalar beams such that the total amplitude of the generated vector beam of light remains the same and as high as possible.

The transmitter arrangement, particularly, the encoder and/or the light beam generating arrangement may be configured to combine the scalar beams of light, one or both being modulated in amplitude by the encoder, to generate a vector beam of light comprising the scalar beams of light. It follows that the light beam generating arrangement may then be configured to transmit the vector beam of light.

It will be understood by those skilled in the art that light beam generating arrangement and/or the encoder may be conventional optical and/or opto-electronic and/or opto-mechanical and/or electronic and/or opto-electronic-mechanical means.

According to a fifth aspect of the invention, there is provide a system for optical communication, wherein the system comprises:
a receiver arrangement for optical communication as described herein; and
a transmitter arrangement for optical communication as described herein.

### BRIEF DESCRIPTION OF THE FIGURES

Non-limiting embodiments of the invention will now be described by way of example only and with reference to the following Figures:

FIG. 1 shows a schematic block diagram of a system for optical communication comprising a receiver arrangement and transmitter arrangement in accordance with an example embodiment of the invention;

FIG. 2 shows an illustration of a conceptual visualisation of a sequence of vector beams with tuneable vectorness;

FIG. 3(a) shows an illustration of an experimental set-up for the generation of vector fields with tuneable concurrence and which measures concurrence after propagating through a heated air channel;

FIG. 3(b) shows example embodiments of multiplexed binary amplitude holograms used to holographically control the concurrence of generated beams via weighting parameter a—associated bit strings are displayed;

FIG. 3(c) show example embodiments of Stokes intensities which are integrated over the dashed circles in order to calculate the concurrence [I_{H}-horizontal, I_{V}—horizontal, I_{D}—diagonal and I_{R}— right-circular polarization intensity projections];

FIG. 4(a) shows received concurrence of an input value varied in 16 discreet steps (inset shows partial results for 8 and 32 steps) through still (solid line) and turbulent (dashed line) air;

FIG. 4(b) shows crosstalk matrices for the emitted and received concurrence through still (top) and turbulent (bottom) air for bases with N=8, 16 and 32 (left to right);

FIG. 4(c) shows 3 Bit (8 level) image transmitted through still (top) and turbulent (bottom) air—dark pixels highlight errors (inset shows the ground truth image) while the values report the image fidelity;

FIG. 5(a) shows mean received concurrence (over 50 points) per element in the N=16 basis in both still (circles) and turbulent (triangles) air, error bars are visible in the inset;

FIG. 5(b) shows distribution of received C values about their target for two example basis elements both without (top) and with (bottom) turbulence—values report the mean deviations across the N=16 basis;

FIG. 5(c) shows measured standard deviation for each element in the N=16 basis through still and turbulent air, where the large overlap illustrates the turbulence invariance;

FIG. 5(d) shows theoretically predicted BER as a function of the statistical spread δC and basis choice N, the solid line represents the points where NδC=1 and dashed lines represent the deviations of the receiver arrangement −δCₛₜᵢₗₗ and δ′C_{turb};

FIG. 6 shows a flow diagram of a method in accordance with an example embodiment of the invention; and

FIG. 7 shows another flow diagram of a method in accordance with an example embodiment of the invention.

### DESCRIPTION OF PREFERRED EMBODIMENTS

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features.

Accordingly, those skilled in the art will recognise that modifications and adaptations to the present invention are possible, and may even be desirable in certain circumstances, and are a part of the present invention. Thus, the following description is provided as illustrative of the principles of the present invention and not a limitation thereof.

It will be appreciated that the phrase “for example,” “such as”, and variants thereof describe non-limiting embodiments of the presently disclosed subject matter. Reference in the specification to “one example embodiment”, “another example embodiment”, “some example embodiment”, or variants thereof means that a particular feature, structure, or characteristic described in connection with the embodiment(s) is included in at least one embodiment of the presently disclosed subject matter. Thus, the use of the phrase “one example embodiment”, “another example embodiment”, “some example embodiment”, or variants thereof does not necessarily refer to the same embodiment(s).

Unless otherwise stated, some features of the subject matter described herein, which are, described in the context of separate embodiments for purposes of clarity, may also be provided in combination in a single embodiment. Similarly, various features of the subject matter disclosed herein which are described in the context of a single embodiment may also be provided separately or in any suitable sub-combination.

The headings used herein are for organizational purposes only and are not meant to be used to limit the scope of the description or the claims. For brevity, the word “may” is used in a permissive sense (i.e., meaning “having the potential to”), rather than the mandatory sense (i.e., meaning “must”).

The words “include,” “including,” and “includes” and the words “comprises”, “comprising”, and “comprises” mean including and comprising, but not limited thereto, respectively. Additionally, as used herein, the term “coupled” may refer to two or more components connected together, whether that connection is permanent (e.g., welded, cast, moulded, carved) or temporary (e.g., bolted, screwed, adhered via an adhesive), direct or indirect (i.e., through an intermediary), mechanical, chemical, optical, or electrical as is the case in a communicatively coupled components which may be in communication with each other wirelessly or in a hardwired fashion.

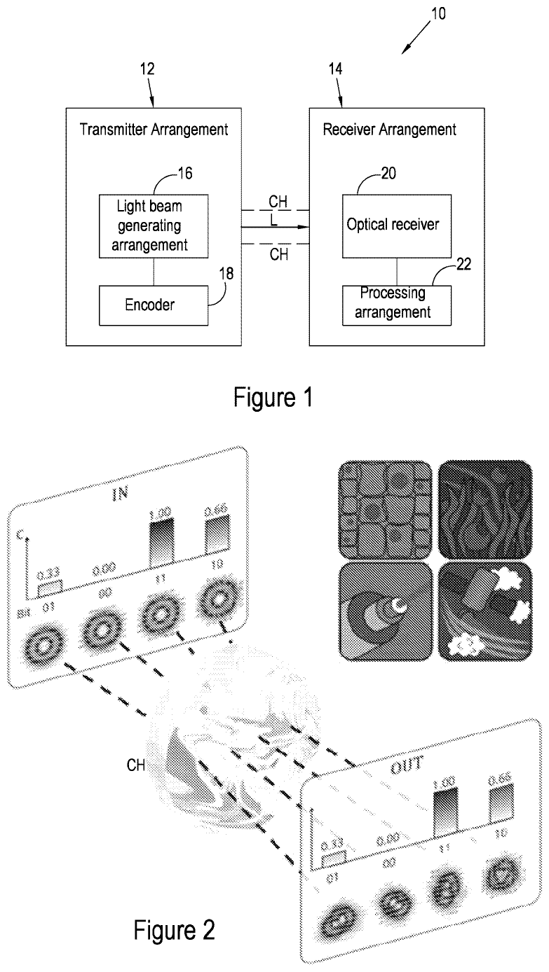

Referring to FIG. 1 of the drawings where a high-level system for optical communication in accordance with an example embodiment of the invention is generally indicated by reference numeral 10. The system 10 is typically comprised of at least one transmitter arrangement 12 and an emitter arrangement 14 which are configured to communicate with each other over a communications channel C which may be optical fiber (e.g., single-mode optical fiber, free space with or without turbulence, underwater, cellular material, or other optical media, or the like.

The system 10 is illustrated to comprise a single transmitter arrangement 12 and single receiver arrangement 14 but those skilled in the art will appreciate that the system 10 may comprise a plurality of arrangements 12 and 14 which may be configured to communicate with each other. It follows that every transmitter arrangement 12 may have a corresponding receiver arrangement 14 located at the same location so and to transmit and receive data optically. To this end, the illustrated system 10 may form part of a wider optical communication network comprised of a plurality of systems 10 which may be geographically spaced.

The transmitter arrangement 12 typically comprises a light beam generating arrangement 16 configured to generate and transmit a vector beam of light L over a communications channel CH. The arrangement 12 further comprises a suitable encoder 18 configured to encode the beam of light L generated by the light beam generating arrangement 16 with information by using a degree of vectorness of the beam of light L as an encoding basis.

The receiver arrangement 14 typically comprises an optical receiver 20 configured to receive the beam of light L carrying information. For example, the beam of light L transmitter from the transmitter arrangement 12. The receiver arrangement 14 also comprises a processing arrangement 22 communicatively coupled to the optical receiver and configured to determine a degree of vectorness of the beam of light received by the optical receiver 20, wherein the processing arrangement 22 is configured to use the determined degree of vectorness of the beam of light L to determine the information carried by said beam of light L received by the optical receiver 20. In this way, the system 10 conveniently exploits polarisation inhomogeneity (vectorness) of vectorial light as a continuous variable encoding basis. Like amplitude, the degree of vectorness of the received beam of light spans 0 (scalar light) to 1 (fully vectorial) but with the pertinent benefit that the value is independent of device and measurement, allowing the full range to be used as a high-dimensional alphabet, rather than the two-dimensional (on/off) amplitude alphabet.

Though described in greater detail herein by way of a theoretical and experimental approaches, it will be understood by those skilled in the art, that analogous or near-analogous real-world hardware to the experimental setup may be employed to realise the high-level optical communication system 10 as contemplated herein.

### Theoretical Discussion

The system 10 as disclosed herein for optical communication typically involves exploiting the spatial mode basis using vector fields of the form:

|Ψ [symbol] =a|ψ₊|H [symbol] +1−a|ψ₋ [symbol] |V [symbol] (1),
where |ψ_{±} [symbol] represents any pair of orthogonal spatial modes, |H(V) [symbol] are the horizontal(vertical) linear polarization Jones vectors and the real amplitude determined by a to ensure that the total power in the field remains constant for a∈[0,1]. Beams of the type described by Equation 1 are ubiquitous and are the natural modes of both optical fibre and free space when |ψ_{±} [symbol] are chosen appropriately. Moreover, it has been shown that fields of this type have a degree of non-separability in their spatial and polarization degrees-of-freedom (DoFs) which can be quantified using a quantum inspired metric (the concurrence), referred to interchangeably herein as the “degree of vectorness”, “vectorness”, “concurrence”, “concurrence value”, or “polarisation inhomogeneity”.

In any event, the concurrence, C, for the field in Equation 1 is given by:

[symbol]

=2 [symbol] \sqrt{ψ₊|ψ₊ [symbol] ψ₋|ψ₋ [symbol] −| [symbol] ψ₊|ψ₋ [symbol] |²} (2)
which reduces to C=2|Sqrt{a(1−a)}| where Sqrt{ } is the square-root function. It will be advantageously noted that weighting parameter a allows C to be varied monotonically from a minimum value of C=0, which represents completely scalar fields (homogeneously polarized), to a maximum of C=1 which represents fields with maximally non-separable spatial and polarization DoFs (inhomogeneously polarized), with the required amplitude modulation trivially found from:

$$a = \frac{1}{2} ( 1 \pm \sqrt{1 - {𝒞}^{2}} ) \qquad ( 3 )$$

It will be noted that both C and a span from 0 to 1, but the invariance of C allows it to be used as a multi-bit encoding basis. This is because all measures of C will agree on the value regardless of the detector type (and will be shown, regardless of the channel conditions), a property inherited from its quantum origin. This is in stark contrast to a measurement of the amplitude, a, directly, where disparate detector efficiencies and channel noise/loss mean no universal agreement on a, thus reducing the full multibit bandwidth spanning 0 through to 1 to just 0 or 1 (one bit) for light or no light.

To use the vectorness as measured by C as an encoding basis, the encoder 18 is configured to assign unique information in the form of bits to values of C separated by ΔC, for N≈1/AC as the number of elements in the basis. This permits the transmitter arrangement 12 to transmit d=log₂ N bits per on/off pulse, rather than the one bit with the traditional non-modal amplitude approach. It will be noted by those skilled in the art that FIG. 2 illustrates this concept visually where initial modes (IN) are passed through an aberrating channel CH and emerge distorted (OUT). Although the spatial mode structure appears scrambled and would have high modal cross-talk, the vectorness remains intact with no cross-talk, and can therefore be used as a multi-bit encoding basis. Here concurrence values of C={0, 0.33, 0.66, 1} are used with N=4 as an example. In other words, the number of vector modes N used for communication is four, wherein each vector mode corresponds to each of the values of concurrence C, wherein C={0, 0.33, 0.66, 1}. For the description herein, turbulence is used as an example channel but as alluded to above, the channel CH could be optical fibre, underwater, cellular media, or the like.

Now that the communication basis from the concurrence of classical vector beams has been defined herein mathematically, investigations were done on how this basis responds to propagation through the atmosphere where spatially varying air densities due to both pressure and temperature variations induce a spatially varying refractive index according to the Gladstone-Dale law. As mentioned, turbulence is selected as an example only, chosen because it represents a particularly dynamic and extreme distorting medium.

In this regard, one may express a total phase change, φ(\vec{r}_{T}), through a width of turbulent medium using a thin screen approximation. This phase acts only on the spatial DoF (Degree of Freedom) via the operator in the position basis

[symbol]

Propagation to the far-field was allowed for phase only distortions to become phase and intensity fluctuations, modelled by using a Fourier transform operator F. It follows that the field, after propagating into the far-field through turbulence, may be expressed as:

|φ_{±} [symbol] = [symbol] \hat{P}_{φ}|ψ_{±} [symbol] (4)

It can be seen by those skilled in the art that an important property of the above transformation is that it is unitary and therefore preserves inner products such that [symbol] φ_{±}|φ_{±} [symbol] = [symbol] ψ_{±}|ψ_{±} [symbol] and [symbol] φ_{±}|φ_{±} [symbol] = [symbol] ψ_{±}|ψ_{±} [symbol] . From Equation 2, it will be appreciated that this implies invariance of the vectorness (concurrence) to the channel CH, and obviously extended to other similar transformations.

The result of this is illustrated in FIG. 2, where the vectorness and the bit-strings they are mapped to are unchanged through the channel—even though the intensity and polarization profiles are severely distorted. Thus theoretically, the potential of vectorness as a robust multi-bit information carrier is shown.

### Experimental Setup and Discussion

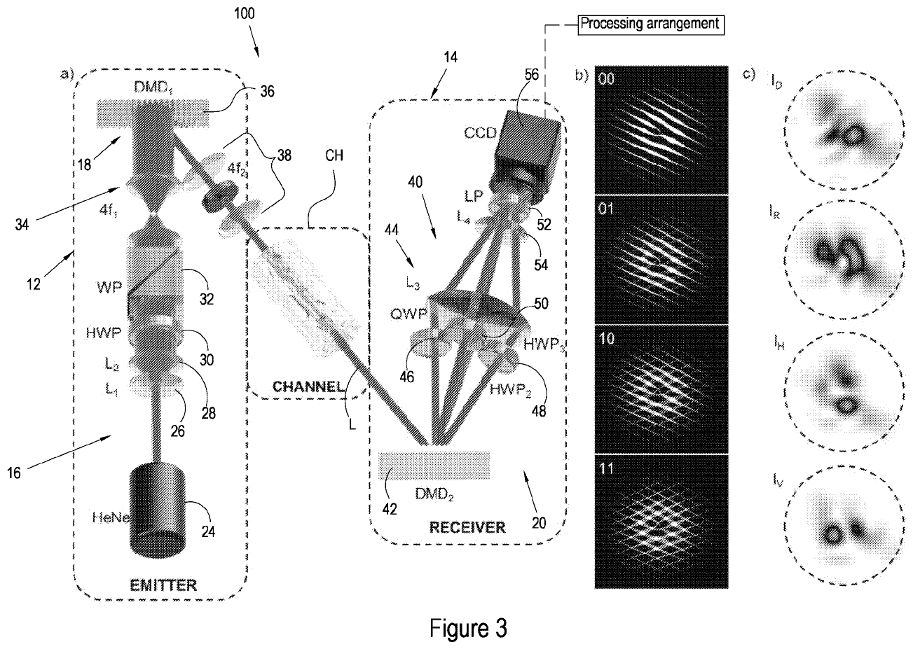

To verify the effectiveness of the optical communication scheme disclosed herein, an experimental set-up as illustrated in FIG. 3(a), which generally corresponds to the system 10, was employed. The experimental setup is generally indicated by reference numeral 100.

It will be understood by those skilled in the art that the experimental setup 100 may approximate a real-world system 10 and the components illustrated and discussed in the experimental setup 100 are to experimentally verify the theoretical discussion above and thus where appropriate, the real-world implementations of the system 10 may therefore be different from the experimental setup 100. Notwithstanding, these differences should be understood by those skilled in the art to not detract from the invention disclosed herein and like parts of the system 10 will be described with reference to like parts of the experimental setup 100.

In any event, the experimental setup 100 comprises a transmitter arrangement 12 comprising a beam generating arrangement 16 configured to generate vector beams of light. To this end, the beam generating arrangement 16 comprises a light source in the form of a laser 24, for example, a laser mated to the communication channel. For example, the laser 24 may be different for fibre and free-space communications. In the experimental setup 100, the laser 24 is in the form of a HeNe laser 24 (wavelength 633 nm) configured to generate a Gaussian beam of light. The arrangement 16 comprises an optical arrangement comprising a plurality of optical elements. For example, the arrangement 16 comprises lenses EL 26 and CL 28 located downstream from the laser 24 to expand and collimate the light beam generated by the laser, respectively.

The beam generating arrangement 16 further comprises a half-wave plate (HWP) 30 downstream from the CL lens 28 to convert the plane of polarization of the beam to 45°. Moreover, the beam generating arrangement 16 comprises a Wollaston prism (WP) 32 which is configured to separate the horizontally and vertically polarized components of the expanded beam at an angle of ~1°.

The plane at the WP 32 was imaged onto the screen of an encoder 18 comprising a digital micro-mirror device (DMD₁) 36 using a Fourier 4f₁ imaging system 34. In the example experimental setup 100, the DMD₁ 36 was addressed using two multiplexed binary holograms of the form:

$${H}_{A / B} ( \vec{r} ) = \frac{1}{2} + \frac{1}{2} sign [ cos ( {φ}_{A / B} ( {\vec{r}}_{T} ) + 2 π ( {\vec{g}}_{T}^{A / B} \cdot {\vec{r}}_{T} ) ) - cos ( {A}_{A / B} ( {\vec{r}}_{T} ) ) ] , \qquad ( 5 )$$

facilitating the modulation of the complex field, wherein

$${U}_{A / B} = {A}_{A / B} {e}^{i {φ}_{A / B}} , where {\vec{g}}_{T}^{A / B} = ( {g}_{x}^{A / B} , {g}_{y}^{A / B} )$$

are grating frequencies.

Examples of the multiplexed gratings corresponding the different concurrence values are shown in FIG. 3(c).

By selecting \vec{g}^{A/B} appropriately, the +1 diffraction orders of independently modulated, orthogonally polarized components were spatially overlapped—creating the desired vector beam |ψ [symbol] . In the case of the experimental setup 100,

$$\vert {ψ}_{\pm } 〉 ≡ {LG}_{o}^{\pm 1}$$

were chosen, where

$${LG}_{p}^{l}$$

is the Laguerre-Gaussian mode with azimuthal(radial) index p(I). The combined diffraction order was isolated using an aperture, A, placed at the focal plane of a second Fourier 4f₂ imaging system 38 located optically downstream of the DMD₁ 36 which directed the beam of light from the transmitter arrangement across the channel CH to the receiver arrangement 14. It will be understood that the DMD₁ 36 providing the two multiplexed binary amplitude holograms facilitates independent complex modulation of horizontally and vertically polarized components of a diagonally polarized (approximate) plane wave in a desired fashion.

To control C, the encoder 18 is controlled to present suitable holograms to the beam of light, prior to transmission over the communications channel CH, wherein the holograms interact with an incident beam of light to produce a vector beam of light L having a predetermined concurrence, C. The encoder 18 may be controllable to present at least one of a plurality of holograms which may result in vector beams of light with a corresponding at least one of a plurality of vectoral modes or concurrence. To this end, the relative efficiencies of the holograms presented by the DMD₁ 36 may be tuned according to Equation 3 by varying the amplitude a. Exemplar multiplexed holograms for a N=4 concurrence basis are shown in FIG. 3(b).

In view of the foregoing, it will be appreciated that the encoder 18 may comprise or may be communicatively coupled to a suitable transmitter side processing arrangement (not shown) which may be substantially like the processing arrangement 22. In this way, the processing arrangement of the transmitter arrangement 12 may be configured to control the DMD₁ 36 to provide specific holograms with desired amplitude a, for communication. Each hologram presented by the DMD₁ 36 may be one of a predetermined number of holograms, each corresponding to one of the predetermined number of vector modes, N. It will be appreciated by those skilled in the art that any encoder 18 which is configured to encode information into, or modulate information onto, the beam of light L by varying its amplitude a, may be used herein in a manner that maintains the total power of the beam of light but adjusts the relative power in each of the two components of the respective vector mode.

In terms of the experimental setup 100, the vectoral beam of light L generated by the transmitter arrangement 12 was passed through a dynamically aberrated channel CH created by a suitable heater set to a steady state temperature of T≈185 °C to induce turbulence in the air along≈200 mm of beam path of the beam of light L.

As mentioned above, the receiver arrangement 14 is configured to receive the vectoral beam of light L via the optical receiver 20. To this end, the optical receiver 20 comprises a Stokes Polarimetry arrangement 40 configured to detect integrated Stokes intensities of the received beam of light L. The processing arrangement 22 is typically configured to determine the Stokes intensity measurements from suitable electrical signals received from the Stokes Polarimetry arrangement 40 communicatively coupled thereto.

The Stokes Polarimetry arrangement 40 may be a single-shot arrangement 40. In this regard, the arrangement 40 comprises a suitable holographic device, for example DMD₂ 42 configured to provide one or more holograms to the beam of light L. In particular, the beam of light L|ψ [symbol] is received by the optical receiver 20 which images the same onto the DMD₂ 42.

The DMD₂ 42 is typically encoded or addressed with multiplexed binary gratings which is configured to diffract four copies of the received beam of light L|ψ [symbol] into the ±1 diffraction orders.

The Stokes Polarimetry arrangement 40 further comprises a suitable optical arrangement 44 downstream, optically, from the DMD₂ 42 comprising one or more components selected from a group comprising quarter-wave plate/s 46, half-wave plate/s 48, 50, linear polariser/s 52 and lenses 54. Moreover, the arrangement 40 comprises a photosensitive arrangement 56 in the form of a CCD camera 56 downstream from the optical arrangement 44 configured to detect the Stokes intensities. The CCD 56 is communicatively coupled to the processing arrangement 22 which is configured to use the detected Stokes intensities (simulated examples of far field Stokes intensities showing the region of integration (dashed circles) are given in FIG. 3(c)) to determine the Stokes measurements which is used by the processing arrangement 22 to calculate the concurrence, C using the following equation:

$$𝒞 = \sqrt{1 - \frac{{( {I}_{H} - {I}_{V} )}^{2} + {( 2 {I}_{D} - {I}_{H} - {I}_{V} )}^{2} + {( 2 {I}_{R} - {I}_{H} - {I}_{V} )}^{2}}{{( {I}_{H} + {I}_{V} )}^{2}}} \qquad ( 6 )$$

where Iᵢ=∫∫Ĩᵢdr_{T} represent the transversely integrated Stokes intensities, the dashed circle in FIG. 3(c) indicating the necessary region of integration.

It will be appreciated that each of the four copies of the received beam of light L|ψ [symbol] that were diffracted by the DMD₂ 42 were passed through different combinations of a quarter-wave plate 46 (QWP—fast axis at 22.5°) and half-wave plates 48, 50 (fast axes at 45 and 22.5°, respectively) and a common linear polarizer 52 (LP—transmission axis at 0°) and lens 54 in order to capture horizontally (Ĩ_{H}), vertically (Ĩ_{V}), diagonally (Ĩ_{D}) and right-circularly (Ĩ_{R}) polarized Stokes intensities, from which the concurrence, C, is calculated by the processing arrangement 22. This follows a standard Stokes measurement except that only integrated intensities are recorded. In this respect the CCD camera can be replaced with a faster, cheaper photodiodes, this is because there is no need for spatial resolution for the invention described herein. This is an advantage of photodiodes and fast optical technologies because cameras are very slow not necessary as the present invention disclosed herein does not require spatially resolving the received beam of light—an integrated beam of light L is used.

The Stokes measurements form an over-complete set of polarisation projections, making decoding of the received beam of light L independent of the polarisation basis that the modes were prepared in, i.e., the sender or the channel can alter the polarization basis without any effect on the outcome. FIG. 3(c) shows exemplar Stokes intensities, from which the concurrence could be determined as described herein.

It will be noted that the processing arrangement 22 is electrically coupled to the CCD 56 to receive intensity values, or data/electrical signals representative of the intensities detected or measured by the CCD 56. The processing arrangement 22 may therefor comprise one or more processors which may typically be one or a combination of microcontrollers, processors, graphics processors, or field programmable gate arrays (FPGAs) operable to achieve the desired operation/s as described herein. The processor arrangement 22 may be operable under instructions stored in an internal memory of the arrangement and/or external memory device (not shown) to perform the operations described or contemplated herein. In particular, the processing arrangement 22 is configured to receive intensity values, or data indicative thereof, from the CCD 56 and use the same to determine the Stokes intensity measurements. Though the CCD 56 is utilised in the experimental setup 100, it will be appreciated by those skilled in the art that less costly photosensitive components such as photodetectors comprising photodiodes may be used in real-world application of the invention disclosed herein.

The processing arrangement 22 is configured to use the Stokes intensity measurements to determine the concurrence, C, of the beam of light L, for example, by way of Equation 6. In particular, using the determined Stokes intensity measurements as input to Equation 6. In this way, the processing arrangement 22 is configured to determine the information in the form of bits associated with the determined concurrence as illustrated visually in FIG. 2. It will be understood though but those skilled in the art that an integrated signal is processed by the optical receiver 20 and no spatial resolution is required.

It will be appreciated that in some example embodiments, the Stokes intensity measurements may substantially correspond to the Stokes Intensities detected by the CCD 56 thus any calculation step by the processing arrangement 22 to obtain the Stokes intensity measurements from the Stokes Intensities detected may thus be avoided.

Though not shown, the system 10, particularly the transmitter arrangement 12 and the receiver module 14, may further comprise an output module (not shown), in the form of a display, for example, an LCD (Liquid Crystal Display), Light Emitting Diode (LED) screen, CRT (Cathode Ray Tube) screen, printer, or the like, communicatively coupled to the processing arrangement 22 to output the information received. Similarly, the system 10 may comprise suitable input modules (not shown) at the transmitter arrangement 12 and the receiver arrangement 14 which may comprise a keyboard, mouse, touchpad, touchscreen, or the like so that user may make inputs to the system 10.

The processing arrangement 22, and the output module need not be in close proximity to the CCD 56 to receive signals indicative of the intensities therefrom. Though not illustrated, it will be understood that the system 10 comprises associated biasing and/or driving circuitry, and a power source, for operating the electrically driven and/or controlled components of the system 10. Similarly, the system 10 may comprise suitable optical elements, and the like for manipulating light in the system 10 in a desired, fashion as described herein.

### Multi-Bit Encoding

As mentioned above, the invention disclosed herein uses and thus exploits a quantum-based measure of concurrence, C, which does not change due to beam distortions, so that the full range from 0 to 1 can be used for optical communication in a user-defined number of steps (N) independent of how perturbing the channel CH is. Each of the steps N may also be referred to as a “vectoral mode”. The number of steps N thus being also referred to as vectoral modes N herein. It will be therefore noted that the communication system 10 may have a predetermined number of vectoral modes which may be selected from a range between, and optionally including, zero to one. In some example embodiments, the processing arrangement 22 may store, in a suitable memory device (internal or external, both not shown) information indicative of the number of vectoral modes N to be used for communication, details of each of the vector modes (particularly their respective concurrence values) and/or bits which they may be associated with said vectoral modes.

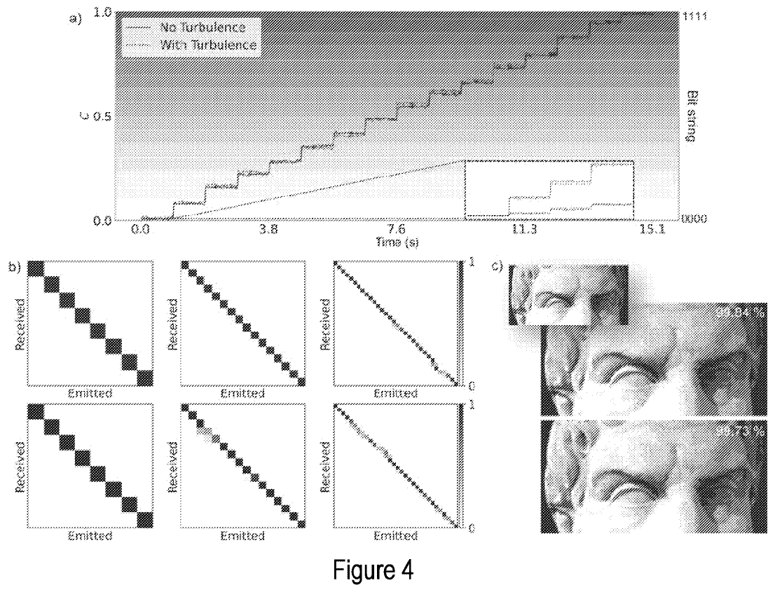

This sub-division of the available encoding space is shown in FIG. 4(a) for N=16 (with N={8, 32} included as an inset). To indicate the low cross-talk, the experimental setup 100 was configured to transmit a vector light beam L which was allowed to “idle” at each basis element (delineated into bins shown as shaded bars) while repeated measurements were taken, confirming only small dynamic changes in still and turbulent air alike.

The robust nature of the encoding is quantified by cross-talk matrices in FIG. 4(b) for up to N=32, corresponding to 32 vectorial modes, yet with low levels of cross-talk. Finally, the experimental setup 100 was used to transmit information over this dynamically changing turbulent channel with no adjustment to the received data signal, resulting in the high-fidelity images shown in FIG. 4(c) for still (top) and turbulent (bottom) air using N=8, that is the number of vectoral modes N=8. The consistency of the results under different channel conditions validates the concept discussed herein. The notable feature of this approach is that the number of modes used can be tailored up to a maximum Nₘₐₓ=1/δC, where δC is the inherent noise in the experimental setup 100 and thus system the 10 in real-world application.

### Noise and Information Capacity

It will be noted from the “idling” results of FIG. 4(a) that the noise of the still and turbulent air is comparable, suggesting that receiver arrangement 14/optical receiver 20 noise is the primary cause of the statistical variation of a given vectorness about the target, as anticipated by theory. In particular, it will be noted that this noise is mostly the CCD 56. It follows that δC is limited primarily by detector/optical receiver 20 noise and not the condition of the channel CH itself.

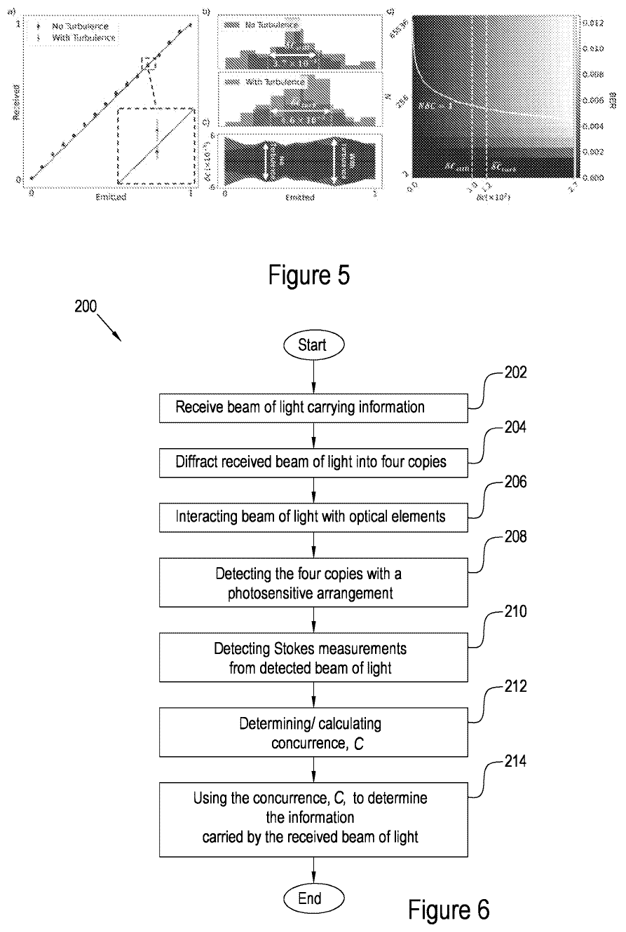

This results in only very small errors between what was emitted and what was received, as illustrated in FIG. 5(a) for N=16 as an example, with the small scale of the deviation shown in the enlarged inset. A statistical analysis of the experimental noise shown graphically in FIG. 5(b) reveals that δCₛₜᵢₗₗ≈3.7×10⁻³ in still air (no turbulence), which may be taken to represent the inherent noise of the optical receiver 22/detection system.

When instantaneous turbulent channel conditions are introduced, only a slight increase in noise to δ′C_{turb}≈4.6×10⁻³ is observed which may be attributable to the signal-to-noise limit of the optical receiver 22, i.e., defocusing aberrations in turbulence leading to a signal below the noise threshold of the optical receiver 22. It is notable that a spread in the received C due to detector noise is akin to the spectral spread observed in OAM due to channel aberrations. However, the noise is not mode specific, as shown by the small difference in variance with and without turbulence in FIG. 5(c). This advantageously validates the submissions herein that the minimum subdivision of the encoding space, or maximum number of modes (or bits), is limited primarily by detector/optical receiver 22 noise and not channel conditions, contrary to traditional MDM schemes.

To probe the potential of the approach disclosed herein, a given detector noise limit (δC) and subdivision choice (N) are investigated to determine how they affect the resulting bit-error-rate (BER), using the turbulence channel CH as an example.

The BER is the ratio of incorrectly received bits to total transmitted bits and represents how crosstalk in the scheme affects the information transfer. The results of this are illustrated graphically in FIG. 5(d). In order to quantify the relationship between the cross-talk inducing δC and the fidelity of the experimental setup 100, an analytical inspection of the overlap of neighbouring basis elements to reveal BER for a given choice of basis (i.e., N) and δC was undertaken:

$$BER ( N , δ𝒞 ) = \overline{E} ( N ) \frac{δ𝒞}{2} \sqrt{\frac{π}{2}} {e}^{- \frac{{N}^{- 2}}{2 δ𝒞}} erf ( \sqrt{\frac{2}{δ𝒞}} ) , \qquad ( 7 )$$

where erf( ) represents the error function and E⁻(N) is the mean bit-error per erroneously binned measurement for a given basis choice.

If the BER is inspected for different channel conditions and basis choices, as shown in FIG. 5(d), one notices how the reducing δC allows for the use of denser choice of basis while maintaining a low BER. The white curve in FIG. 5(d) indicates the special cases of NδC=1, with the associated line acting as a limit for the basis size under a given channel condition. Notably, this overlap is significantly lower than the modal overlap experienced by MDM systems, and that with a suitable detector acceptable BERs on the order of 10⁻⁹ are plausible. These results indicate that the effectiveness of the technique for high dimensional information transfer places the burden only on the signal-to-noise ratio of the detector system/optical receiver 22.

The notably poor diffraction efficiency offered by DMDs in general means that the optical receiver 22 provided in the experimental setup 100 suffers from a lower signal-to-noise ratio (SNR) than alternatives, such as metasurface-based polarization cameras, gradient-index lens polarimeters or positive operator value measurements.

The white dashed lines in FIG. 5(d) indicate the mean measured δC for the experimental setup 100 with and without turbulence. The associated BER(N=8)≈2 ×10⁻³ also agrees well with the fidelities reported in FIG. 4(c).

It follows from the foregoing that the invention disclosed herein reveals its potential for multi-bit encoding using a new modal version of amplitude modulation, enabling a d-fold increase in information density using existing amplitude modulation technology for superior data transmission rates. Unlike MDM systems, the source of noise in the invention disclosed herein is primarily detector/optical receiver based, while being almost completely invariant to channel aberrations, negating the need for adaptive error-correction, which was modelled experimentally in the experimental setup 100 by using atmospheric turbulence as an extreme example.

This was illustrated by using 8 spatial modes in a turbulent channel with a cross-talk that is comparable to the no-turbulence case (0.27%). For comparison, crosstalk observed between 4 orthogonal vector modes have been shown to reach=20% even in weak turbulence conditions, while crosstalk between 7 neighbouring scalar

$${LG}_{p}^{l}$$

modes reached 13.2% even with corrective measures.

The observed BER with the experimental setup 100 disclosed herein was in the order of 2×10⁻³ and is comparable to that achieved in error-corrected MDM systems.

As mentioned herein, even though the experimental setup 100 provided a proof-of-principle, it will be understood by those skilled the art that the invention disclosed herein and the system 10 may be immediately deployable with conventional telecom technology, requiring only traditional amplitude modulation at the transmitter arrangement 12 (acting only on scalar modes) and photodiodes plus signal analysis at the receiver arrangement 14. The optics associated with the vectorial creation and Stokes measurements are all static and can be off-the-shelf elements.

Referring now to FIG. 6 of the drawings where a high-level flow diagram of a method in accordance with an example embodiment of the invention is generally indicated by reference numeral 200.

The method 200 may be achieved with the system 10 as described herein, the experimental setup 100 described herein, or other optical systems not described herein but understood by those skilled in the art achieve the methodology described herein.

The method 200 is typically an optical communication method to decode or determine the information carried by a received beam of light, typically a vectoral beam of light L carrying information as described herein. It will be understood a beam of light carrying information described herein may be synonymous with a beam of light encoded with information.

The method 200 comprises receiving, at block 202, the beam of light L carrying information. The method 200 comprises receiving the vector beam of light L with the receiver arrangement 14, particularly the optical receiver 20, as described herein. As described herein, the beam of light L may be encoded with information in/on a vectoral basis at the transmitter arrangement 12, for example, in a manner as described herein.

The method 200 comprises diffracting, at block 204, the received beam of light L into at least four copies thereof. This may be achieved by way of the DMD₂ 42 of the optical receiver 20 providing multiplexed holograms to the received beam of light L to diffract four substantially identical copies of the received beam of the light L.

The four identical copies of the received beam of light L may travel in four beam paths with the optical arrangement interacting with one or more of the beams in the four beam paths. The method 200 therefore comprises interacting, at block 206, the at least four copies of the received beam of light with one or more optical elements selected from a group comprising quarter-wave plate/s 46, half-wave plate/s 48, 50, and lens/es 52, 54.

The method 200 comprises detecting, at block 208, each of four copies of the received beam of light after interacting with the aforementioned optical elements. To this end, the photosensitive arrangement, which in the experimental setup 100 is in the form of a CCD 56 is configured to detect the Stokes intensities associated with the four beams of light after interaction with the aforementioned optical elements.

The Stokes intensities detected by the CCD 56 as represented by suitable electrical signals may be used as the Stokes intensity measurements contemplated herein but in some example embodiments, the method 200 may comprise determining, at block 210, the Stokes intensity measurements. In this regard, the processing arrangement 22 is configured to process electrical signals received from the CCD 56, which electrical signals are representative of the detected Stokes intensities.

Notwithstanding, the processing arrangement 22 is configured to determine a horizontally polarised Stokes intensity measurement (Ĩ_{H}), a vertically polarised Stokes intensity measurement (Ĩ_{V}), a diagonally polarised Stokes intensity measurement (Ĩ_{D}), and a right-circularly polarised Stokes intensity measurement (Ĩ_{R}) associated with the received beam of light L from the at least four copies of the received beam of light detected by the CC 56.

The method 200 comprises using, at block 212, the determined Stokes intensity measurements to calculate the concurrence, C. To this end, the processing arrangement 22 may be configured to use the determined Stokes intensity measurements to determine the concurrence, C, by way of Equation 6 above. It will be appreciated that in other example embodiments, the processing arrangement 22 may be configured to determine the concurrence in other ways from the detected Stokes intensities, for example, by integrating the regions illustrated in FIG. 3(c) mathematically.

Lastly, the method 200 comprises using the determined or calculated degree of vectorness of the received beam of light L/value of concurrence, C, to determine the information carried by the received beam of light L. For example, with reference to FIG. 2, the concurrence C of 0.33 is associated with bit 01, and the concurrence of 1 is associated with bit 11, etc. In other words, the vector mode with a concurrence C of 0.33 is associated with bit 01. this way, optical communication is realised using the vectoral nature of the beam of light as the communication basis.

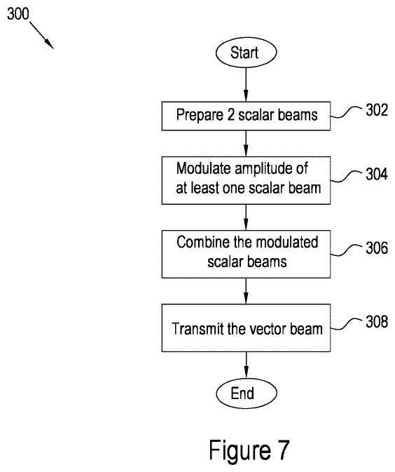

Referring to FIG. 7 of the drawings where another method in accordance with an example embodiment of the invention is generally indicated by reference numeral 300. The method 300 is typically a method for transmitting data in an optical communication system, for example, the system 10, experimental setup 100, or other optical transmission systems having suitable equipment to achieve the methodology described herein.

The method 300 comprises preparing, at block 302, two scalar beams of light, each beam of light having a polarisation which is orthogonal to a polarisation of the other beam of light. It will be understood that this is a conventional step which may be achieved by the light beam generating arrangement 16 and/or other arrangements as is well understood in the art.

The method 300 comprises modulating one or both of the scalar beams of light in amplitude, at block 304, such that the resultant vector beam of light L has a predetermined vectorness or degree of vectorness or vectoral/vector mode/s as described herein. It will be appreciated that one or both of the scalar beams may be modulated amplitude, i.e., dimming the amount of light associated with one or both beams from a maximum (of 1) to a minimum (of 0) in a manner which does not change the total light in the beam, or in other words the total power of the vector beam of light L. For example, of one of the scalar beams of light is modulated with an amplitude of a, the other is modulated with an amplitude of 1−a. In this regard, it will be understood that it is useful to keep the signal as high as possible and always the same in total but not in each part.

The method 300 then comprises combining the scalar beams of light, at block 306, to generate a vector beam of light comprising the two scalar beams of light, wherein the vector beam of light has a predetermined vectoral/vector mode or concurrence associated therewith. The combining of the scalar beams may be achieved in many ways, including the holographic approach described herein. Those skilled in the art will appreciate that the light beam generating arrangement 16 could also comprise a static optical device where the two scalar beams go into the device and are combined to form the vector beam of light L described herein.

It follows that the vector mode of the vector beam of light generated is determined by the amplitude of one or both of the scalar beams of light, wherein the vector beam holds the modulated beam/s of light and thus information in its associated vector mode or concurrence as determined by a suitable coding scheme. For example, C=0.1=bit “001”, C=0.2=bit “010”, etc.

The method 300 then comprises transmitting the generated vector beam of light L over the communications channel CH in a conventional fashion.

It will be appreciated that each vector/vectoral mode of light may be associated with information for optical communication. In this regard, the method may comprise modulating one of both of the scalar beam/s of light in amplitude such that the generated vector beam of light has a predetermined degree of vectorness or vectoral/vector mode as described herein. The method may comprise modulating the amplitude/s of one or both the scalar beams to have a combined amplitude of 1. In other words, the method may comprise modulating the amplitude/s of one or both the scalar beams such that the total amplitude of the generated vector beam of light remains the same and as high as possible.

The method may comprise combining the scalar beams of light, one or both being modulated in amplitude, to generate a vector beam of light comprising the scalar beams of light.

It will be appreciated that each vector/vectoral mode of light may be associated with information for optical communication. It follows that modulating one or both of the scalar light beam/s in amplitude may comprise encoding information into one or both the scalar light beams by way of amplitude so that the resultant vector beam of light is associated with a particular vectoral/vector mode. In other words, the amplitude of the scalar beam/s may be varied to thereby to vary the vectoral/vector modes and thus the information transmitted.

It will be understood for the foregoing that a core feature of the invention disclosed herein is the utilization of inhomogenously polarised spatial modes (vector beams) in a manner that does not require the spatial modes nor orthogonal polarisation components to be detected or recognised. Instead, only their vectorness is detected, an invariant quantity that is found by an integrated modal signal. In this way, the optical receiver 20 is configured to collect all the receive signals for each beam of light L, an integrated signal, and not spatially resolved as is usually the case. This means that the present invention does not require a camera and can use fast photodiodes.

It follows that while the proof-of-principle experimental setup used a CCD camera 56 for detection, fast and sensitive photodetectors such as photodiodes are all that is required and more preferable for a real-world implementation, as discussed above. Because the channel-invariant basis is derived from spatial modes without actually detecting them and is independent of the polarisation basis that they were prepared in, the invention disclosed herein brings with it some significant benefits over traditional MDM schemes that use the modes themselves as the basis. For instance, (i) system misalignment is mitigated since the integrated detection is spatially invariant, (ii) the modes can be selected with low order to reduce divergence (since more information does not require more modes), (iii) like amplitude modulation, the invention disclosed herein does not prohibit other enhancement schemes such as wavelength division multiplexing (WDM) to further improve information density, including even MDM if modal correction is applied, and further, (iv) unlike alternative vectorial techniques, the nature of the invention described herein is over-complete even in the polarisation basis, and therefore means that the sender and receiver do not have to agree on the measurement basis, allowing the scheme to work even in polarization scrambling media such as stressed optical fibre. These benefits are provided by the vectorness, a physical quantity which displays resilience to transformations which generally hinder modal communication systems. The trade-off lies in the scaling of the invention described herein, to increase d by 1, N must double. This places the burden of performance on the power and amplitude modulation resolution of the emitter arrangement 12 and the SNR of the receiver arrangement 14, all factors which already receive considerable attention in free space optical communication systems.

The invention as disclosed herein uses the vectorness of vectorial light as a new modal version of amplitude modulation, exploiting spatial modes in a manner that makes them channel-invariant, with the number of modes used limited primarily by the sensitivity of the detectors used. The experimental setup 100 has demonstrated high fidelity, correction-free, multi-bit information transfer to verify the methodology disclosed herein, even through dynamic turbulence, an extreme example of a communications channel. The invention disclosed herein can be extended to other channels too, such as optical fibre and under-water, since the invariance property will hold in all such channels. The invention disclosed herein may open up a new avenue for high-bandwidth optical communication, with the immediate benefits of MDM but without the modal cross-talk challenges associated therewith. The vectorness presents a new scheme for information encoding, which if coupled with other communication techniques such as WDM and SDM, can be used to push the boundaries of optical communication.

Differently stated, the invention as described herein provides a different approach to optical communication, foregoing the discrete modal basis of MDM and instead exploiting the polarisation inhomogeneity (vectorness) of vectorial light as a continuous variable encoding basis. Like amplitude, it spans 0 (scalar light) to 1 (fully vectorial) but with the pertinent benefit that the value is device independent, allowing the full range to be used as a high-dimensional alphabet rather than the two-dimensional (on/off) amplitude alphabet. Because the vectorness is an invariant quantity, it remains intact even in the presence of aberrations where all parties will receive the same information regardless of their particular channel conditions. In this way, the invention disclosed herein provides a means for optical communication free of modal-noise without the need for adaptive optics or digital corrective procedures, with the dimensionality of the encoding primarily limited by detector noise. Moreover, the invention as disclosed herein proposes a replacement of conventional amplitude modulation with a modal alternative for potentially orders of magnitude channel information enhancement, offering a new approach to exploiting structured light for optical communication.

Moreover, it will be noted that the disclosure herein leverages on the understanding of light's classical and quantum degrees of freedom and finds invariances that leaves the information noise-resilient, ideally noise-free. For instance, in early-stage research it has been shown theoretically and in laboratory demonstrations that one can find the eigenmodes of complex channels that pass through the medium unperturbed and that giving light a topology can be make it resilient to some forms of noise (pertinently, background noise). In more advanced stage research, it has been shown that vectorial light has a hidden invariance: a degree of non-separability called concurrence in quantum physics but which we term vectorness in the context of classical light. It measures how hard it is to separate the polarization pattern of the light from the intensity pattern (spatial mode), a classical analogue to quantum entanglement. The vectorness varies from a minimum value of 0 (a scalar field that is 100% separable) to a maximum value of 1 (a fully vector field that is 100% non-separable). Although the intensity, phase and polarization are all distorted, the vectorness value remains invariant. The scheme disclosed herein is therefore a paradigm shift: exploiting spatial modes of light for communication but in a way that does not require them to be “recognized” by the detectors. Indeed, the detectors disclosed herein are just light integrators: photodiodes. It has been shown that the 0 to 1 range can be sub-divided up to the noise limit of the detectors used, for a multi-bit encoding scheme: vectorness is used to encoded information, sent across a noisy channel, and decoded on the other side in a manner that is essentially free of channel noise, with only detector and background noise remaining. Using this it has been shown that ~50 modes (carrying 50 values of vectorness) could be sent across a very noisy turbulent channel, far surpassing the limit with conventional spatial modes, with the number limited only by the cheap and non-ideal detectors.

1. A method for optical communication, wherein the method comprises:
receiving a beam of light carrying information; and
determining a degree of vectorness of the received beam of light, wherein the determined degree vectorness is used to determine the information carried by the received beam of light.

2. The method as claimed in claim 1, wherein the received beam of light is encoded with information in the form of one or more bits using the vectorness of the beam of light as an encoding basis.

3. The method as claimed in claim 2, wherein the beam of light is a vector vortex beam of light.

4. The method as claimed in claim 1, wherein the degree of vectorness is a vectoral mode from a range between, and including, zero and one.

5. The method as claimed in claim 4, wherein the range comprises a plurality of vectoral modes from between zero and one, and wherein each vectoral mode has one or more bits associated therewith.

6. The method as claimed in claim 1, wherein determining the degree of vectorness of the received beam of light comprises determining a measure of quantum entanglement of the received beam of light.

7. The method as claimed in claim 6, wherein the measure of quantum entanglement of the received beam of light is the concurrence of the received beam of light.

8. The method as claimed in claim 7, wherein the method comprises determining concurrence of the received beam of light by:
determining integrated Stokes intensity measurements associated with the received beam of light; and
using the determined integrated Stokes intensity measurements to calculate the concurrence of the received beam of light.

9. The method as claimed in claim 7, wherein the method comprises:
diffracting the received beam of light into at least four copies of the received beam of the light;
interacting the at least four copies of the received beam of light with one or more optical elements selected from a group comprising quarter-wave plate/s, half-wave plate/s, and lens/es;
detecting each of the at least four copies of the received beam of light after interacting with the one or more optical elements by way of a photosensitive arrangement that collects an integrated signal with no spatial resolution;
determining a horizontally polarised Stokes intensity measurement (I_{H}), a vertically polarised Stokes intensity measurement (I_{V}), a diagonally polarised Stokes intensity measurement (I_{D}), and a right-circularly polarised Stokes intensity measurement (I_{R}) associated with the received beam of light from the at least four copies of the received beam of light detected by the photosensitive arrangement; and
using the determined Stokes intensity measurements to calculate the concurrence.

10. The method as claimed in claim 9, wherein the method comprises diffracting the received beam of light into the at least four copies of the received beam of the light by way of one or more multiplexed holograms.

11. The method for optical communication, wherein the method comprises encoding a beam of light with information by using a degree of vectorness of the beam of light as an encoding basis.

12. The method as claimed in claim 11, wherein the method comprises preparing a vector beam of light for optical communication.

13. The method as claimed in claim 11, wherein the method comprises:
preparing at least two scalar beams of light, each beam of light having a polarisation which is orthogonal to a polarisation of the other beam of light;
modulating one or both of the scalar beams of light in amplitude such that the resultant vector beam of light has a predetermined degree of vectorness associated with information to be transmitted;
combining the scalar beams of light to generate a vector beam of light comprising the two scalar beams of light; and
transmitting the vector beam of light.

14. A receiver arrangement for optical communication, wherein the receiver arrangement comprises:
an optical receiver configured to receive a beam of light carrying information; and
a processing arrangement communicatively coupled to the optical receiver and configured to determine a degree of vectorness of the beam of light received by the optical receiver, wherein the processing arrangement is configured to use the determined degree of vectorness to determine the information carried by the beam of light received by the optical receiver.

15. The receiver arrangement as claimed in claim 14, wherein the processing arrangement is configured to determine the degree of vectorness of the received beam of light by determining concurrence of the received beam of light.

16. The receiver arrangement as claimed in claim 15, wherein the processing arrangement is configured to determine concurrence of the received beam of light by:
determining Stokes intensity measurements associated with the received beam of light; and
using the determined Stokes intensity measurements to calculate the concurrence.

17. The receiver arrangement as claimed in claim 14, wherein the optical receiver comprise a Stokes Polarimetry arrangement configured to detect Stokes intensities associated with the received beam of light, wherein the Stokes Polarimetry arrangement is communicatively coupled to the processing arrangement so that the processing arrangement is able to determine the Stokes intensity measurements associated with the received beam of light therefrom.

18. The receiver arrangement as claimed in claim 17, wherein the Stokes Polarimetry arrangement comprises one or more a suitable holographic device/s configured to provide one or more holograms to the beam of light received by the optical receiver.

19. The receiver arrangement as claimed in claim 18, wherein the holographic device is configured to provide suitable multiplexed holograms which are configured to diffract four copies of the received beam of light into ±1 diffraction orders.

20. The receiver arrangement as claimed in claim 18, wherein the Stokes Polarimetry arrangement further comprises:
a suitable optical arrangement downstream from the one or more holographic device/s comprising one or more components selected from a group comprising quarter-wave plate/s, half-wave plate/s, linear polariser/s, and lenses; and
a photosensitive arrangement downstream from the optical arrangement configured to detect the Stokes intensities.

21. The receiver arrangement as claimed in claim 18, wherein the processor arrangement is configured to:
determine a horizontally polarised Stokes intensity measurement (I_{H}), a vertically polarised Stokes intensity measurement (I_{V}), a diagonally polarised Stokes intensity measurement (I_{D}), and a right-circularly polarised Stokes intensity measurement (I_{R}) associated with the received beam of light; and
use the determined Stokes intensity measurements to calculate the concurrence.

22. A transmitter arrangement for optical communication, wherein the transmitter arrangement comprises:
a light beam generating arrangement configured to generate and transmit a vector beam of light over a communications channel; and
a suitable encoder configured to encode the beam of light generated by the light beam generating arrangement with information by using a degree of vectorness of the beam of light as an encoding basis.

23. The transmitter arrangement as claimed in claim 22, wherein the light beam generating arrangement comprises a suitable light source and suitable optical and/or holographic elements configured to prepare a vector beam of light for optical communication.

24. The transmitter arrangement as claimed in claim 23, wherein the light beam generating arrangement is configured to prepare at least two scalar beams of light to be used to generate the vector beam of light, each scalar beam of light having a polarisation which is orthogonal to a polarisation of the other beam of light.

25. The transmitter arrangement as claimed in claim 24, wherein the encoder is configured to modulate one of both of the scalar beam/s of light in amplitude such that the generated vector beam of light has a predetermined degree of vectorness for use as an encoding basis.

26. The transmitter arrangement as claimed in claim 25, wherein the encoder is configured to modulate the amplitude/s of one or both the scalar beams to have a combined amplitude of 1 or as close to 1 as possible.

27. A system for optical communication, wherein the system comprises:
a receiver arrangement for optical communication comprising;
an optical receiver configured to receive a beam of light carrying information; and
a processing arrangement communicatively coupled to the optical receiver and configured to determine a degree of vectorness of the beam of light received by the optical receiver, wherein the processing arrangement is configured to use the determined degree of vectorness to determine the information carried by the beam of light received by the optical receiver; and
a transmitter arrangement for optical communication comprising:
a light beam generating arrangement configured to generate and transmit a vector beam of light over a communications channel; and
a suitable encoder configured to encode the beam of light generated by the light beam generating arrangement with information by using a degree of vectorness of the beam of light as an encoding basis.
